(19) United States
(12) Patent Application Publication
(10) Pub. No.: US 2024/0063929 A1
(43) Pub. Date: Feb. 22, 2024

(54) OPERATING METHOD FOR ELECTRONIC DEVICE

(71) Applicant: InnoCare Optoelectronics Corporation, Tainan City (TW)

(72) Inventor: Hui-Ru Tsai, Tainan City (TW)

(73) Assignee: InnoCare Optoelectronics Corporation, Tainan City (TW)

(21) Appl. No.: 18/346,853

(22) Filed: Jul. 4, 2023

(30) Foreign Application Priority Data
Aug. 16, 2022 (TW) 111130797

(51) Int. Cl. H04B 17/327; H04W 28/02

(52) U.S. Cl. CPC H04B 17/327; H04W 28/0236

(57) ABSTRACT

An operating method for electronic device is provided, which is applied to a detecting device to perform operations. The electronic device has access to a first wireless internet access point (AP). The electronic device includes a display panel and a sensing device. The operating method includes the following operations. A received signal strength indication (RSSI) of a second wireless internet AP is detected. When the RSSI of the second wireless internet AP is greater than or equal to a first threshold value, the display panel displays an RSSI of the first wireless internet AP and the RSSI of the second wireless internet AP. A sensing operation is received through the sensing device. In response to the sensing operation, the electronic device has access to the second wireless internet AP.

### CROSS-REFERENCE TO RELATED APPLICATION

This application claims the priority benefit of Taiwan application serial no. 111130797, filed on Aug. 16, 2022. The entirety of the above-mentioned patent application is hereby incorporated by reference herein and made a part of this specification.

### BACKGROUND

### Technical Field

The disclosure relates to an operating method for an electronic device, and in particular relates to an operating method for a detecting device to detect access points.

### Description of Related Art

A wireless internet device is, for example, a wireless internet access point (AP). The wireless internet access points are widely disposed in multiple spaces, so that terminal devices may access the wireless internet access points anywhere to receive and/or transmit signals. For example, terminal devices (such as X-ray detectors) used in medical treatment or security inspection may move from different clinics or different spaces. Since the access range covered by the wireless internet access point is limited, when the terminal device moves in different spaces, it is necessary to use an external computer to set the accessed internet access point, perform a “hand-off” operation, cut off the originally accessed wireless internet access point, and establish (internet) access to the wireless internet access point in the space where the terminal device is currently located. Therefore, every time the terminal device performs a hand-off operation, an external computer must be used to perform the aforementioned settings, which causes inconveniences.

### SUMMARY

An embodiment of this disclosure provides an operating method for an electronic device, which is applied to detecting device to perform operations. The operating method may automatically search for a wireless internet access point for a user to perform a hand-off operation, and is more convenient in use.

The operating method of the embodiments of this disclosure is applied to electronic device to perform operations. A detecting device has access to a first wireless internet access point. The electronic device includes a display panel and a sensing device. The operating method of the embodiment of this disclosure includes the following steps. A received signal strength indication of a second wireless internet access point is detected. When the received signal strength indication of the second wireless internet access point is greater than or equal to a first threshold value, the display panel displays a received signal strength indication of the first wireless internet access point and the received signal strength indication of the second wireless internet access point. A sensing operation is received through the sensing device. In response to the sensing operation, the electronic device has access to the second wireless internet access point.

Based on the above, the operating method of the embodiment of this disclosure may detect the received signal strength indication of the second wireless internet access point. In addition, the operating method may respectively display the received signal strength indication of the currently accessed first wireless internet access point and the detected second wireless internet access point through the display panel, and perform the hand-off operation according to the sensing operation to access the second wireless internet access point, so the electronic device may automatically search for the signal strength indication of the wireless internet access point without having to set up an additional computer to perform related operations, so as to facilitate the user to decide whether to access the new wireless internet access point. Therefore, the operating method offers great convenience.

In order to make the aforementioned features and advantages of the disclosure comprehensible, embodiments accompanied with drawings are described in detail below.

### BRIEF DESCRIPTION OF THE DRAWING

FIG. 1 is a flowchart of an operating method of a detecting device according to an embodiment of this disclosure.

FIG. 2 is a block diagram of the detecting device according to the embodiment of FIG. 1 of this disclosure.

FIG. 3 is a flowchart of an operating method of another embodiment of this disclosure.

FIG. 4A is a top schematic diagram of the detecting device of the embodiment of FIG. 3.

FIG. 4B is a side schematic diagram of the detecting device of the embodiment of FIG. 3.

FIG. 4C is a schematic diagram of an image displayed by the display panel of the detecting device in the embodiment of FIG. 4B.

FIG. 5 is a schematic diagram of an implementation scenario of the detecting device according to the embodiment of FIG. 3 of this disclosure.

### DETAILED DESCRIPTION OF DISCLOSED EMBODIMENTS

Certain terms may be used throughout the disclosure and the appended patent claims to refer to specific elements. It should be understood by those skilled in the art that display device manufacturers may refer to the same elements by different names. The disclosure does not intend to distinguish between elements that have the same function but have different names. In the following description and patent claims, words such as “comprising” and “including” are open-ended words, so they should be interpreted as meaning “including but not limited to . . . ”.

In this disclosure, the terms “about,” “substantially,” generally mean within 10%, within 5%, within 3%, within 2%, within 1%, or within 0.5% of a given value or range. The quantity given here is an approximate quantity, that is, even though “about,” “substantially,” are not specified, the meaning of “about,” “substantially,” are still implied. Furthermore, the terms “range between a first value to a second value” mean that the range includes the first value, the second value, and other values in between.

In some embodiments of the disclosure, terms related to joining and connecting, such as “connected”, “interconnected”, etc., unless otherwise defined, may mean that two structures are in direct contact, or may also mean that two structures are not in direct contact, in which there are other structures located between these two structures. The terms related to joining and connecting can also include the case where both structures are movable, or both structures are fixed. Furthermore, the term “coupled” includes any direct and indirect means of electrical connection. Furthermore, the term “connected” includes a means of signal communication by which two elements or devices can directly or indirectly receive and/or transmit wireless signals.

The terms such as “first”, “second”, etc. used in the description and the claims are used to modify elements, which do not imply and represent that the elements have any previous ordinal numbers, and also does not represent the order of a certain element and another element, or the order of the manufacturing method. The use of the ordinal numbers is to only clearly distinguish an element with a certain name from another element with the same name. The same terms may not be used in the patent claims and the description, and accordingly, the first component in the description may be the second component in the patent claims. It should be noted that, in the following embodiments, the technical features in several different embodiments can be replaced, reorganized, and mixed to complete other embodiments without departing from the spirit of the disclosure.

The electronic device of this disclosure may include electronic elements. The electronic device may include, for example, a display device, a light-emitting device, an antenna device, a detecting device 200, a touch display, a curved display, or a free shape display, but not limited thereto. The electronic device may be a bendable or flexible electronic device. The electronic device may include, for example, light emitting diode, fluorescence, phosphor, other suitable display media, or a combination thereof, but not limited thereto. Electronic elements may include passive and active elements, such as capacitors, resistors, inductors, diodes, transistors, and the like. The diode may include a light emitting diode or a photodiode. The light emitting diode may include, for example, an organic light-emitting diode (OLED), a mini light-emitting diode (mini LED), a micro light-emitting diode (micro LED), or a quantum dot light-emitting diode (quantum dot, QD, such as QLED, QDLED), or other suitable materials, or any arrangement and combination of the materials thereof, but not limited thereto. The display device may include, for example, but not limited to, a spliced display device. The antenna device may be, for example, a liquid crystal antenna, but not limited thereto. It should be noted that, the electronic device can be any arrangement and combination of the foregoing, but not limited thereto. In addition, the shape of the electronic device may be rectangular, circular, polygonal, a shape with curved edges, or other suitable shapes. The electronic device may have peripheral systems such as a driving system, a control system, a light source system, a shelf system, etc. to support a display device or a spliced device. It should be noted that, the electronic device can be any arrangement and combination of the foregoing, but not limited thereto. The electronic device may include multiple components, at least two of which may be assembled to form a composite object. Hereinafter, the detecting device is used as the electronic device to illustrate this disclosure, but this disclosure is not limited thereto.

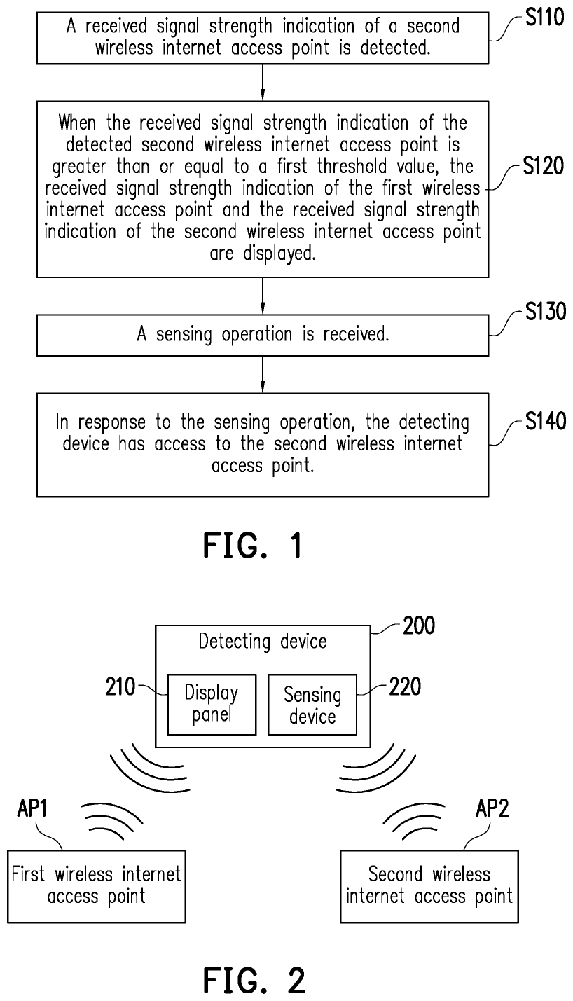

FIG. 1 is a flowchart of an operating method of a detecting device according to an embodiment of this disclosure. FIG. 2 is a block diagram of the detecting device according to the embodiment of FIG. 1 of this disclosure. Referring to FIG. 1 and FIG. 2, the operating method includes steps S110 to S140. The operating method is applied to detecting device 200 to perform operations.

In this embodiment, the detecting device 200 may be, for example, a mobile terminal device. In some embodiments, the detecting device 200 may be, for example, a mobile X-ray detector. In the embodiment shown in FIG. 2, the detecting device 200 includes a display panel 210 and a sensing device 220. The display panel 210 is coupled to the sensing device 220.

In this embodiment, the display panel 210 may display an image to provide information. The display panel 210 may include, for example, an inorganic light-emitting diode (LED), an organic light-emitting diode (OLED), etc. to provide a display panel with a display function. In some embodiments, the display panel 210 may be, for example, a liquid crystal display (LCD) and a display panel that adopts a cold cathode fluorescent lamp (CCFL) or a light-emitting diode as a backlight device to provide a display function, this disclosure is not limited thereto.

In this embodiment, the sensing device 220 may sense actions (i.e., sensing operations) performed by a finger and/or a stylus on the detecting device 200. The sensing device 220 may be, for example, a capacitive sensor, an acceleration sensor, an optical sensor, an electromagnetic sensor, or a combination thereof. In this embodiment, the sensing device 220 may be disposed in an area other than the area of the display panel 210 for displaying images. In some embodiments, the sensing device 220 may be integrated in the display panel 210 and may overlap with the area of the display panel 210 for displaying images. In this embodiment, the display panel 210 may be a touch display panel, but this disclosure is not limited thereto.

In some embodiments, the detecting device 200 further includes a processor (not shown) and a non-transitory computer-readable storage medium (not shown). The processor is coupled to the display panel 210, the sensing device 220, and the non-transitory computer-readable storage medium. The processor may be, for example, a central processing unit (CPU), or other programmable general-purpose or special-purpose microprocessor, a digital signal processor (DSP), a programmable controller, an application specific integrated circuit (ASIC), a programmable logic device (PLD) or other similar devices or a combination of the devices thereof, that may be loaded into relevant firmware or software stored in a non-transitory computer-readable storage medium to control the display panel 210 and the sensing device 220 to perform corresponding operations.

In some embodiments, the detecting device 200 further includes a communication module (not shown). The communication module is coupled to the processor. The communication module may establish wireless signal access with a wireless internet device (e.g., a wireless internet access point) to receive and/or transmit signals. The wireless module may include signal transmission and sensing elements that support, for example, a global system for mobile communication (GSM), a personal handy-phone system (PHS), a code division multiple access (CDMA) system, a wideband code division multiple access (WCDMA) system, a long term evolution (LTE) system, a worldwide interoperability for microwave access (WiMAX) system, a wireless fidelity (Wi-Fi) system, or Bluetooth. In some embodiments, the communication module may be implemented, for example, in an integrated circuit or a chip.

In this embodiment, steps S110 to S140 may be applied to the following exemplary cases. In this embodiment, the detecting device 200 may access the first wireless internet access point AP1. It should be noted that the access method between the detecting device 200 and the first wireless internet access point AP1 is wirelessly bridged (i.e., a wireless communication connection).

In step S110, the received signal strength indication (RSSI) of the second wireless internet access point AP2 is detected by the detecting device 200. In this embodiment, the second wireless internet access point AP2 is another wireless internet access point that has not yet been accessed by the detecting device 200. The number of the second wireless internet access points AP2 in this embodiment may be one or more, which is not limited in this disclosure.

In step S120, when the detected received signal strength indication of the second wireless internet access point AP2 is greater than or equal to the first threshold value, the received signal strength indication of the first wireless internet access point AP1 and the received signal strength indication of the second wireless internet access point AP2 are displayed by the display panel 210 of the detecting device 200. In this embodiment, the first threshold value represents a wireless internet access point that may provide the lowest received signal strength indication required for use, which may provide an environment where the detecting device 200 has a better received signal strength indication after the hand-off operation is performed, to perform signal reception and/or transmission. The first threshold value may be, for example, −67 decibel-milliwatts (dBm), so that the detecting device 200 is capable of transmitting video data, but this disclosure is not limited thereto. It should be noted that when the received signal strength indication of the second wireless internet access point AP2 is greater than or equal to the first threshold value, the second wireless internet access point AP2 may be a better wireless internet access point.

In this embodiment, the user may browse the received signal strength indication of the first wireless internet access point AP1 that is currently accessed (i.e., wirelessly bridged), and browse the detected received signal strength indication of the second wireless internet access point AP2. In this embodiment, the user may also perform a sensing operation (e.g., sliding, tapping, etc.) on the sensing device 220 to confirm that the hand-off operation is performed to the detecting device 200.

In step S130, the sensing operation is received by the sensing device 220. In this embodiment, the sensing operation in step S130 means confirming the hand-off operation is performed to the detecting device 200. At this time, the detecting device 200 cuts off the access to the first wireless internet access point AP1 and establishes the access to the second wireless internet access point AP2.

In step S140, in response to the sensing operation received in step S130, the detecting device 200 has access (i.e., wirelessly bridged) to the second wireless internet access point AP2.

It is worth mentioning here that the detecting device 200 may automatically detect other wireless internet access points (e.g., the second wireless internet access point AP2) that have not yet been accessed, without the need for additional detection by other devices (e.g., a computer). On the other hand, when the detected received signal strength indication of the second wireless internet access point AP2 is greater than or equal to the first threshold value, the aforementioned received signal strength indication may be displayed by the display panel 210, so that the detecting device 200 may perform the hand-off operation according to the sensing operation of the user. In this way, the detecting device 200 may avoid switching the wireless internet access point by externally connecting other devices, and is more convenient in use.

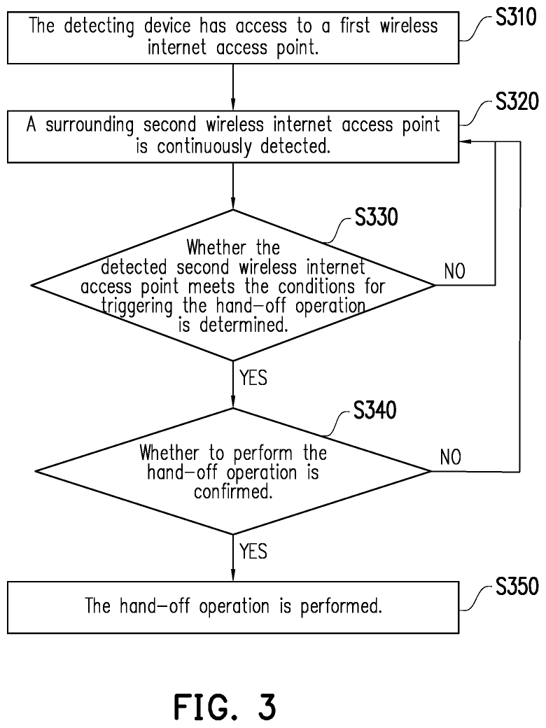

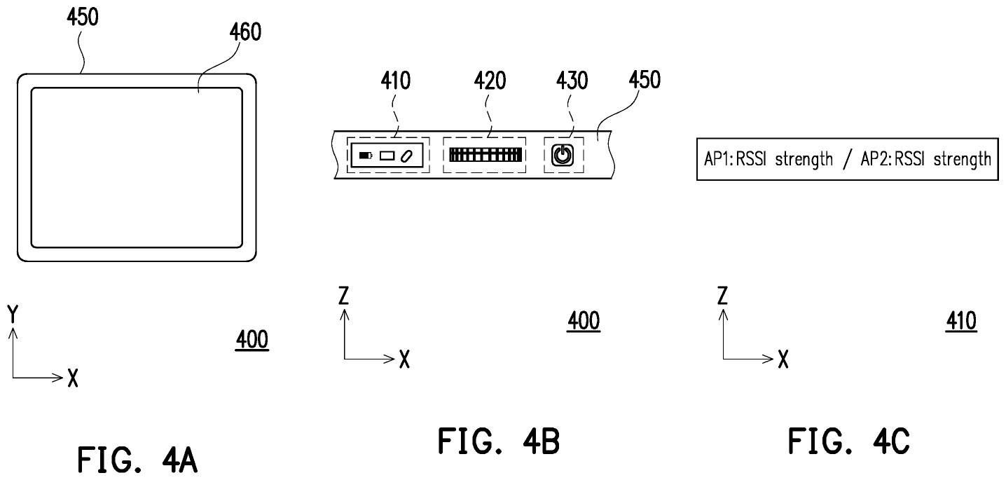

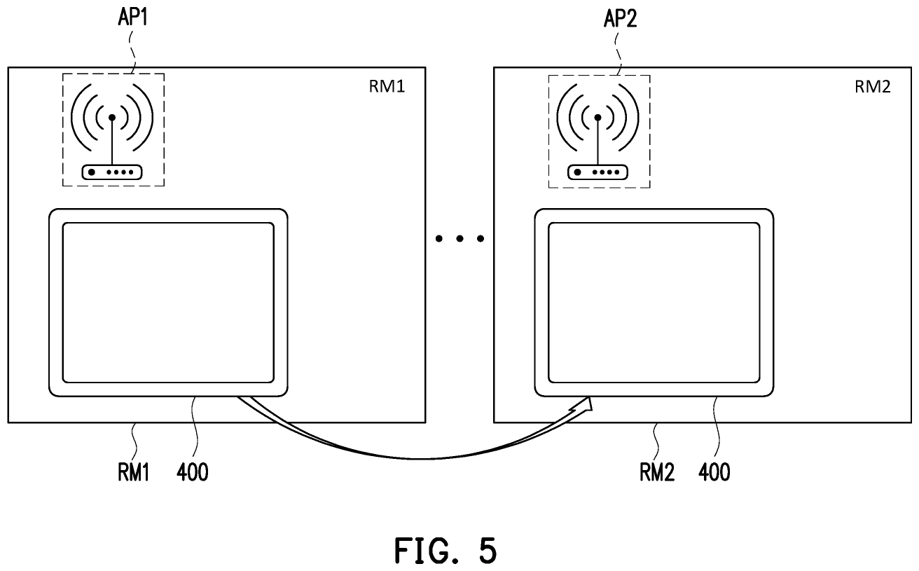

FIG. 3 is a flowchart of an operating method of another embodiment of this disclosure. FIG. 4A is a top schematic diagram of the detecting device of the embodiment of FIG. 3. FIG. 4B is a side schematic diagram of the detecting device of the embodiment of FIG. 3. Referring to FIG. 3, FIG. 4A, and FIG. 4B, the operating method includes steps S310 to S350. The operating method is applied to the detecting device 400 to perform a hand-off operation.

In this embodiment, the detecting device 400 includes a detecting surface 460 and a side surface 450, and includes a display panel 410 and a sensing device 420 disposed on the side surface 450. For the display panel 410 and the sensing device 420, reference may be made to the relevant description of the detecting device 200, so it is not repeated herein. The detecting surface 460 may receive external electromagnetic waves (e.g., visible light or invisible light) to generate image data. In this embodiment, the detecting device 400 may be, for example, a mobile X-ray detector or other devices used in medical treatment or security inspection to generate image data.

In this embodiment, the detecting device 400 further includes a power switch 430. The power switch 430 may turn the detecting device 400 on or off.

In the embodiment shown in FIG. 4A, the X-Y plane formed by the X axis and the Y axis is the top view plane of the detecting device 400. On the X-Y plane, the detecting device 400 has a detecting surface 460.

In the embodiment shown in FIG. 4B, the X-Z plane formed by the X axis and the Z axis is the side view plane of the detecting device 400. The display panel 410, the sensing device 420, and the power switch 430 are disposed on the side surface 450 of the detecting device 400. The number and disposition of the display panel 410, the sensing device 420, and the power switch 430 in this embodiment are only examples, and are not limited thereto.

In this embodiment, the display panel 410 may display patterns and/or text to indicate the access (i.e., wirelessly bridged) status of the detecting device 400 and/or the prompt information of the hand-off operation. The image displayed on the display panel 410 may be, for example, as shown in the embodiment of FIG. 4C, but this disclosure is not limited thereto.

FIG. 4C is a schematic diagram of an image displayed by the display panel 410 of the detecting device 400 in the embodiment of FIG. 4B. Referring to FIG. 4C together, in this embodiment, the image displayed on the display panel 410 includes the name (e.g., “AP1”) of the internet access point currently accessed (i.e., the wirelessly bridged) and its received signal strength indication (e.g., “RSSI strength” corresponding to “AP1”). The image displayed on the display panel 410 also includes the name (e.g., “AP2”) of the detected internet access point and its received signal strength indication (e.g., “RSSI strength” corresponding to “AP2”).

In this embodiment, the sensing device 420 may be, for example, a touch device, but this disclosure is not limited thereto. The sensing operation received by the sensing device 420 includes sliding a distance on the sensing device 420, for example, a user touches the surface of the sensing device 420 and slides a distance along the surface of the sensing device 420. In some embodiments, the sensing device 420 may be, for example, an acceleration sensor. The sensing operation received by the sensing device 420 includes tapping on the sensing device 420, for example, the user may adjust the force or frequency of tapping the surface of the sensing device 420. In some embodiments, the sensing device 420 may be, for example, a combination of a touch device and an acceleration sensor. The sensing operation received by the sensing device 420 includes the aforementioned sliding, tapping, or a combination thereof, but this disclosure is not limited thereto.

In some embodiments, the detecting device 400 further includes a buzzer (not shown). The buzzer is coupled to the processor (not shown). When the display panel 410 displays a pattern and/or text, the buzzer may emit a sound to remind the user to confirm the access (i.e., wirelessly bridged) status of the detecting device 400 and/or the prompt information of the hand-off operation.

In this embodiment, the sensing device 420 and the communication module (not shown) in the detecting device 400 may be implemented by, for example, a chip. The aforementioned chip may be integrated into the display panel 410 or integrated into a processor (not shown). It should be noted that the aforementioned chips may support various communication protocols to perform corresponding operations to implement the hand-off operation.

For example, in this embodiment, the chips of the aforementioned detecting device 400 (i.e., the sensing device 420 and the communication module) may support the 802.11k protocol standard. The detecting device 400 may know about the distribution status of the Wi-Fi access points in the space through the chip, so that the mobile IP of the chip is accessed from the wireless internet access point with weak received signal strength indication (i.e., wirelessly bridged) to another wireless access point with strong received signal strength indication. For another example, in this embodiment, the chip of the detecting device 400 may support the 802.11v protocol standard. The detecting device 400 may select to access (i.e., wirelessly bridge) one of the other multiple wireless internet access points according to the load condition of the wireless internet access point to balance the load. When the detecting device 400 is in a standby status or does not receive and/or transmit wireless signals, the detecting device 400 may also adjust the duration of access to the accessed wireless internet access point, so as to prolong the battery life of the detecting device 400. For yet another example, in this embodiment, the chip of the detecting device 400 may support the 802.11r protocol standard. When the detecting device 400 has access to different wireless internet access points, the detecting device 400 may pre-share the access code of the wireless internet access points through fast basic service set transition (FT). Therefore, the authentication operation time required for re-accessing with each wireless internet access point may be reduced and the access setting operation may be accelerated.

FIG. 5 is a schematic diagram of an implementation scenario of the detecting device according to the embodiment of FIG. 3 of this disclosure. Referring to FIG. 3 and FIG. 5, steps S310 to S350 are applied to the detecting device 400 to perform a hand-off operation. The detecting device 400 in FIG. 5 is, for example, a top schematic view of the detecting device 400 (i.e., the embodiment of FIG. 4A), which is used as an example for description.

In this embodiment, steps S310 to S350 may be applied to the following exemplary cases. The access method between the detecting device 400 and the wireless internet access point may be accessed in a wireless bridge (i.e., a wireless communication connection). In this embodiment, the detecting device 400 is currently located in a first space RM1 (e.g., a room). The detecting device 400 may move in different spaces, for example, from the first space RM1 to the second space RM2 (i.e., another room). The first space RM1 and the second space RM2 may be spaces corresponding to different rooms, or may be different areas within the same space but far apart, the disclosure is not limited thereto.

In step S310, the detecting device 400 is in the first space RM1 and has access (i.e., wirelessly bridged) to the first wireless internet access point AP1.

In step S320, the detecting device 400 continuously detects the surrounding second wireless internet access point AP2. Specifically, in this embodiment, the detecting device 400 may continuously detect other wireless internet access points that have not yet established access to the detecting device 400. Therefore, when the detecting device 400 leaves the first space RM1 and moves to the second space RM2, the detecting device 400 may continuously detect other wireless internet access points (e.g., the second wireless internet access point AP2) that have not yet established access to the detecting device 400. In some embodiments, when the detecting device 400 does not move, the detecting device 400 may also continuously detect other wireless internet access points in the first space RM1 that have not yet established access to the detecting device 400.

In step S330, the detecting device 400 determines whether the detected second wireless internet access point AP2 meets the conditions for triggering the hand-off operation.

If the result of step S330 is yes, it means that the second wireless internet access point AP2 meets the conditions for triggering the hand-off operation, and step S340 is performed.

If the result of step S330 is no, it means that the second wireless internet access point AP2 does not meet the conditions for triggering the hand-off operation, and the process returns to step S320. In this embodiment, if the conditions for triggering the hand-off operation are met, for example, if the received signal strength indication of the second wireless internet access point AP2 is greater than or equal to the first threshold value, and the received signal strength indication of the first wireless internet access point AP1 is reduced to a level that is less suitable as a wireless internet access point, the hand-off operation is triggered.

In this embodiment, the conditions for triggering the hand-off operation in step S330 include that the detecting device 400 detects conditions such as a wireless internet access point with a specific service set identifier (SSID), a received signal strength indication of the wireless internet access point, and/or the duration that the received signal strength indication is greater than or equal to the first threshold value, etc., but this disclosure is not limited thereto.

Specifically, in this embodiment, the condition for triggering the hand-off operation may include that the detected second wireless internet access point AP2 has the same SSID as the accessed first wireless internet access point AP1.

In this embodiment, the condition for triggering the hand-off operation may include that the detected received signal strength indication of the second wireless internet access point AP2 is greater than or equal to the first threshold value, so as to ensure that the received signal strength indication to be accessed (i.e., not wirelessly bridged) in the second space RM2 may better meet the usage requirements. The first threshold value may be, for example, −67 dBm, but this disclosure is not limited thereto.

In this embodiment, the condition for triggering the hand-off operation may include that the detected received signal strength indication of the second wireless internet access point AP2 is greater than or equal to the first threshold value for a time length greater than a preset time length to ensure that the received signal strength indication to be accessed (i.e., not wirelessly bridged) in the second space RM2 is relatively stable. The preset time length may be, for example, 5 seconds. That is to say, when the detecting device 400 detects that the received signal strength indication of the second wireless internet access point AP2 is continuously greater than or equal to −67 dBm for longer than 5 seconds, the second wireless internet access point AP2 meets the condition for triggering the hand-off operation and may be used as a candidate accessible wireless internet access point for the detecting device 400.

In this embodiment, the condition for triggering the hand-off operation may include that the received signal strength indication of the accessed (i.e., wirelessly bridged) first wireless internet access point AP1 is less than a second threshold value, indicating that the currently accessed (i.e., wirelessly bridged) received signal strength indication does not meet the usage requirements of the detecting device 400. The second threshold value may be, for example, −70 dBm. When the received signal strength indication is less than the second threshold value, the detecting device 400 may not be able to operate stably, for example, may not be able to transmit complete digital data. That is to say, when the received signal strength indication of the first wireless internet access point AP1 is less than −70 dBm, and when the received signal strength indication of the second wireless internet access point AP2 is greater than or equal to −67 dBm and continuously maintains for at least 5 seconds, the second wireless internet access point AP2 meets the conditions for triggering the hand-off operation and may be used as a newly accessed wireless internet access point. At this time, the first wireless internet access point AP1 also meets the conditions for triggering the hand-off operation and may be cut off. At this time, the display panel 410 displays the name and received signal strength indication of the first wireless internet access point AP1 and the name and received signal strength indication of the second wireless internet access point AP2.

Since the detecting device 400 may operate stably in a space with better received signal strength indication, in some embodiments, a hand-off operation is forced to trigger, and the condition may include that the received signal strength indication of the accessed (i.e., wirelessly bridged) first wireless internet access point AP1 is less than the first threshold value for a time length that is greater than the aforementioned preset time length, which means that the currently accessed (i.e., wirelessly bridged) received signal strength indication is unstable. Meanwhile, if the received signal strength indication of the second wireless internet access point AP2 detected by the detecting device 400 is also lower than the first threshold value, it means that the first wireless internet access point AP1 accessed by the detecting device 400 in the current space cannot provide the detecting device 400 with a relatively stable operation, and the detecting device 400 has not found a suitable wireless internet access point for access. For example, when the received signal strength indication of the first wireless internet access point AP1 is less than −67 dBm continuously for more than 5 seconds, and the received signal strength indication of the second wireless internet access point AP2 is also less than −67 dBm, no matter if the access to the first wireless internet access point AP1 is continuous or the access is changed to the second wireless internet access point AP2, the detecting device 400 may not be able to operate stably. In order to reduce the impact of the first wireless internet access point AP1 on the stable operation of the detecting device 400, the access between the detecting device 400 and the first wireless internet access point AP1 is cut off. Next, the detecting device 400 returns to step S320 to continuously detect other wireless internet access points. When the detecting device 400 finds a wireless internet access point that meets the aforementioned conditions for triggering the hand-off operation, the detecting device 400 prompts the user through a display panel (e.g., the display panel 410 shown in FIG. 4B), and after confirmation by the user, the wireless internet access point may be accessed to the detecting device 400.

In other embodiments, the hand-off operation is triggered forcibly triggered, and the condition may include that the received signal strength indication of the accessed (i.e., wirelessly bridged) first wireless internet access point AP1 is greater than or equal to a first threshold value (e.g., −67 dBm) for a time length that is greater than the aforementioned preset time length, indicating that the received signal strength indication of the first wireless internet access point AP1 in the space where the detecting device 400 is currently located may provide the detecting device 400 with stable operation. At the same time, if the detected received signal strength indication of the second wireless internet access point AP2 is greater than or equal to the first threshold value (e.g., −67 dBm) for a time length that is also greater than the aforementioned preset time length, it means that the received signal strength indication of the second wireless internet access point AP2 that is not yet accessed (i.e., not wirelessly bridged) in the space where the detecting device 400 is currently located may also provide the detecting device 400 with stable operation. That is to say, when both the accessed first wireless internet access point AP1 and the not yet accessed second wireless internet access point AP2 may provide the detecting device 400 with stable operation, the condition for the hand-off operation is still triggered. The detecting device 400 prompts the user through a display panel (e.g., the display panel 410 shown in FIG. 4B). At this time, the detecting device 400 continues to perform step S340.

In some other embodiments, the hand-off operation is forcibly triggered, and the condition may include that the received signal strength indication of the accessed (i.e., wirelessly bridged) first wireless internet access point AP1 is less than a first threshold value (e.g., −67 dBm) or the received signal strength indication of the first wireless internet access point AP1 is less than the first threshold value and greater than or equal to the second threshold value (e.g., −70 dBm) for a time length that is greater than the aforementioned preset time length (i.e., the received signal strength indication of the first wireless internet access point AP1 is less than −68 dBm or between −68 dBm and −70 dBm), which means that the first wireless internet access point AP1 may still provide the detecting device 400 with a relatively stable operation. At the same time, if the detected received signal strength indication of the second wireless internet access point AP2 is greater than or equal to the first threshold value (e.g., −67 dBm) for a time length that is greater than the aforementioned preset time length, it means that the received signal strength indication of the second wireless internet access point AP2 that is not yet accessed (i.e., not wirelessly bridged) in the space where the detecting device 400 is currently located may provide the detecting device 400 with a relatively stable operation. That is to say, when both the accessed first wireless internet access point AP1 and the not yet accessed second wireless internet access point AP2 may provide the detecting device 400 with a relatively stable operation, the hand-off operation is still triggered. The detecting device 400 prompts the user through a display panel (e.g., the display panel 410 shown in FIG. 4B). At this time, the detecting device 400 continues to perform step S340.

In step S340, when the detected second wireless internet access point AP2 meets the conditions for triggering the hand-off operation, the access status of the wireless internet access point of the detecting device 400 and the prompt information of the hand-off operation are displayed through the display panel of the detecting device 400 (e.g., the display panel 410 shown in FIG. 4B). The user may confirm whether to perform the hand-off operation according to the aforementioned displayed information. Specifically, when the second wireless internet access point AP2 meets the conditions for triggering the hand-off operation, the display panel may display the received signal strength indication of the first wireless internet access point AP1 and the received signal strength indication of the second wireless internet access point AP2.

In this embodiment, the user may perform a sensing operation (e.g., sliding, tapping, etc.) on the sensing device (e.g., the sensing device 420 shown in FIG. 4B) of the detecting device 400 according to the information displayed on the display panel to confirm whether to perform the hand-off operation to the detecting device 400.

For example, in one embodiment, the display panel may be a touch display panel, and the displayed image may include the respective names and the corresponding received signal strength indication of the first wireless internet access point AP1 and the second wireless internet access point AP2, and multiple patterns. These patterns are, for example, lit in sequence to form a flickering effect, or patterns of arrows, to prompt the user to confirm the hand-off operation by sliding toward the flickering direction or the arrow direction. In one embodiment, the user may swipe a distance to the right on the sensing device to indicate confirmation to perform the hand-off operation. In one embodiment, the user may swipe a distance to the left on the sensing device to indicate confirmation to not perform the hand-off operation. However, this disclosure is not limited thereto.

In one embodiment, the user may tap the sensing device 420 at a first frequency (e.g., three taps within 2 seconds) to indicate confirmation of the hand-off operation. In one embodiment, the user may tap the sensing device 420 at a second frequency (e.g., tap once within 2 seconds) to indicate confirmation not to perform the hand-off operation. However, this disclosure is not limited thereto.

It should be noted that, if the detecting device 400 is applied to medical detection, the detecting device 400 needs to perform internet settings (e.g., performing a hand-off operation) during a period other than the medical detection, so as to reduce the probability that the detecting device 400 cannot operate stably. In this embodiment, through the procedure of step S340, the user of the detecting device 400 may manually confirm whether to perform the hand-off operation, and the user may confirm the relevant information of the wireless internet access point and confirm whether the hand-off operation is performed during the period other than the medical detection performed by the detecting device 400, thereby reducing the probability that the detecting device 400 cannot operate stably.

If the result of step S340 is yes, it means that the user confirms that the detecting device 400 performs the hand-off operation, and then step S350 is performed.

If the result of step S340 is no, it means that the user confirms that the detecting device 400 does not perform the hand-off operation, and then returns to step S320.

In step S350, the detecting device 400 performs the hand-off operation in response to the sensing operation such as sliding or tapping in step S340, cuts off the currently accessed wireless internet access point and establishes access to the new wireless internet access point.

Specifically, in this embodiment, the process of performing the hand-off operation includes that the detecting device 400 has access to the second wireless internet access point AP2 first. Next, the detecting device 400 cuts off the access between the detecting device 400 and the first wireless internet access point AP1.

It should be noted that since the detecting device 400 first establishes access to the second wireless internet access point AP2, and the access to the original first wireless internet access point AP1 is cut off after confirming the completion of the aforementioned access, therefore, the probability of instantaneous disconnection of the wireless signal is reduced when the hand-off operation is performed with the detecting device 400.

In some embodiments, the process of performing the hand-off operation includes that the detecting device 400 first cuts off access to the first wireless internet access point AP1. Next, the detecting device 400 has access to the second wireless internet access point AP2.

It should be noted that the detecting device 400 first cuts off access to the original first wireless internet access point AP1, and then establishes access to the second wireless internet access point AP2. The detecting device 400 does not perform other operations until the hand-off operation is completed, so the usage scenario of the detecting device 400 is not affected.

To sum up, the operating method of the embodiment of this disclosure may perform hand-off operation to the electronic device. The operating method may eliminate the need to select other wireless internet access points that have not been accessed through an external computer, and may automatically detect the surrounding wireless internet access points. In addition, when the detected wireless internet access point may provide the electronic device with a relatively stable operation, the operating method may also perform a hand-off operation according to the received sensing operation to switch the accessed wireless internet, thereby the operating method is more convenient in use. In some embodiments, confirming whether to perform the hand-off operation by manually performing the sensing operation may reduce the probability of erroneous operation of the electronic device in use.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and their equivalents and not by the above detailed descriptions.

What is claimed is:

1. An operating method for an electronic device, the electronic device having access to a first wireless internet access point and comprising a display panel and a sensing device, the operating method comprising:
detecting a received signal strength indication of a second wireless internet access point;
wherein when the received signal strength indication of the second wireless internet access point is greater than or equal to a first threshold value, the display panel displays a received signal strength indication of the first wireless internet access point and the received signal strength indication of the second wireless internet access point;
receiving a sensing operation through the sensing device; and
wherein in response to the sensing operation, the electronic device has access to the second wireless internet access point.

2. The operating method for the electronic device according to claim 1, wherein the sensing device is a touch device.

3. The operating method for the electronic device according to claim 2, wherein the sensing operation comprises sliding on the sensing device.

4. The operating method for the electronic device according to claim 1, wherein the sensing device is an acceleration sensor.

5. The operating method for the electronic device according to claim 4, wherein the sensing operation comprises tapping on the sensing device.

6. The operating method for the electronic device according to claim 1, wherein in response to the sensing operation, the electronic device has access to the second wireless internet access point comprises:
the electronic device first has access to the second wireless internet access point; and
then, the electronic device cuts off access to the first wireless internet access point.

7. The operating method for the electronic device according to claim 1, wherein in response to the sensing operation, the electronic device has access to the second wireless internet access point comprises:
the electronic device first cuts off access to the first wireless internet access point; and
then, the electronic device has access to the second wireless internet access point.

8. The operating method for the electronic device according to claim 1, further comprising:
wherein when the received signal strength indication of the first wireless internet access point is less than the first threshold value for a time length that is greater than a preset time length, and when the received signal strength indication of the second wireless internet access point is less than the first threshold value, the access between the electronic device and the first wireless internet access point is cut off.

9. The operating method for the electronic device according to claim 1, wherein when the received signal strength indication of the second wireless internet access point is greater than or equal to the first threshold value, the display panel displays the received signal strength indication of the first wireless internet access point and the received signal strength indication of the second wireless internet access point comprises:
the received signal strength indication of the first wireless internet access point is greater than or equal to the first threshold value for a time length greater than a preset time length.

10. The operating method for the electronic device according to claim 1, wherein when the received signal strength indication of the second wireless internet access point is greater than or equal to the first threshold value, the display panel displays the received signal strength indication of the first wireless internet access point and the received signal strength indication of the second wireless internet access point comprises:
the received signal strength indication of the first wireless internet access point is less than the first threshold value for a time length greater than a preset time length.

11. The operating method for the electronic device according to claim 1, wherein the sensing device is disposed in an area other than an area of the display panel for displaying images.

12. The operating method for the electronic device according to claim 1, wherein the sensing device is integrated in the display panel and overlaps with the area of the display panel for displaying images.

13. The operating method for the electronic device according to claim 1, the electronic device being a detecting device.

14. The operating method for the electronic device according to claim 13, the detecting device being a mobile X-ray detector.

15. The operating method for the electronic device according to claim 13, the detecting device being applied to medical detection, and internet settings being performed during a period other than the medical detection.

16. The operating method for the electronic device according to claim 1, the detecting device further comprising a communication module.

17. The operating method for the electronic device according to claim 1, the detecting device performing access settings to the first wireless internet access points and the second wireless internet access point through fast basic service set transition.

18. The operating method for the electronic device according to claim 1, the first wireless internet access points and the second wireless internet access point being located in different spaces.

19. The operating method for the electronic device according to claim 1, the first wireless internet access points and the second wireless internet access point being located in different areas of a same space.

20. The operating method for the electronic device according to claim 1, the electronic device further comprising a buzzer,
wherein when the display panel displays the received signal strength indication of the first wireless internet access point and the received signal strength indication of the second wireless internet access point, the buzzer emits a sound.
